(19) United States
(12) Patent Application Publication
(10) Pub. No.: US 2022/0289444 A1
(43) Pub. Date: Sep. 15, 2022

(54) MULTI-LAYER STRETCH HOOD FILM WITH ENHANCED TEAR STRENGTH

(71) Applicant: Dow Global Technologies LLC, Midland, MI (US)

(72) Inventors: Shaun Parkinson, Tarragona (ES); Salma El Marrasse Zarioui, Tarragona (ES)

(73) Assignee: Dow Global Technologies LLC, Midland, MI (US)

(21) Appl. No.: 17/605,802

(22) PCT Filed: Apr. 20, 2020
(86) PCT No.: PCT/US2020/028955

§ 371 Date: Oct. 22, 2021

Related U.S. Application Data
(60) Provisional application No. 62/837,794, filed on Apr. 24, 2019.

(51) Int. Cl. B65D 65/40; B32B 27/08; B32B 27/32; C08L 23/06

(52) U.S. Cl. CPC B65D 65/40; B32B 27/08; B32B 27/32; C08L 23/06; B32B 2250/242; B32B 2250/05; B32B 2250/40; B32B 2270/00; B32B 2307/72; B32B 2307/732; B32B 2553/00; C08L 2207/064; C08L 2207/066

(57) ABSTRACT

The present disclosure provides a multi-layer film. The multi-layer film includes a first outer layer and a second outer layer, where at least one of the first and the second outer layers comprises a first polyethylene; a core layer between the first and second outer layers, where a thickness of the core layer is 8 to 30% of a total thickness of the multi-layer film. The core layer is formed from a core polymer comprised of 20 to 0 wt. % of a second polyethylene and 80 to 100 wt. % of a propylene-based elastomer having a density of 0.855 g/cm³ to 0.877 g/cm³, the wt. % based on a total weight of the core layer. The multi-layer film comprises 8 to 30 wt. % of the propylene-based elastomer, based on a total wt. % of the multi-layer film. The multi-layer film also includes a first and a second inner layer, where at least one of the first and the second inner layers comprises 80 to 100 wt. % of a LLDPE having a density of 0.870 g/cm³ to 0.912 g/cm³ and 20 to 0 wt. % of a LDPE, where the core layer is positioned between the first and the second inner layers.

### TECHNICAL FIELD

The present disclosure relates generally to multi-layer films and more particularly to multi-layer stretch hood films with enhanced tear resistance.

### BACKGROUND

A stretch hood is a tube of film sealed on one end, which is stretched over a palletized load to secure the contents to the pallet. The film is cut to the appropriate length, heat sealed on the top end, and gathered on four ‘fingers.’ These fingers stretch the film in the horizontal (cross) direction until the film dimensions are slightly larger than the load dimensions, then draw the stretched film down over the pallet, unrolling it as they move. By varying the unrolling rate, a degree of vertical (machine) direction stretch can be obtained to better hold the load on the pallet. At the bottom of the pallet, the fingers release the film, which typically wraps under the pallet bottom.

The stretch hood is a demanding application, requiring a film with good tear and/or puncture resistance and a balance of holding force and elasticity. Stretch hood films, however, are known to suffer from tears particularly in the machine direction during both the stretch hood process (e.g., as the stretch hood is unrolled over the palletized load) and once applied to the load. When stretch hood films are applied to a load they are stretched in the cross direction and then placed over the load on the pallet. The stretch hood film is under tension while securing the load to the pallet. Once under tension, the stretch hood film is at a greater risk for a machine direction tear that once started can quickly “unzip” the film vertically and therefore not secure the load. Such tears often occur as the secured load is being moved via a fork lift truck. Thicker stretch hood films can also help prevent punctures and unintended tears in the stretch hood film. So, improving the resistance to machine direction tear in films used for stretch hoods is of great interest.

### SUMMARY

The present disclosure provides for a multi-layer film that helps to improve the tear resistance of stretch hood films. In addition, the multi-layer film of the present disclosure helps to achieve improved reduction in machine direction tear failure all while being downgauged, which helps to reduce raw material usage while improving pallet load containment. In addition to improvements in reducing machine direction tear failures and reducing raw material usage via downgauging the multi-layer film of the present disclosure improves load stability, which again helps with pallet load containment.

For the various embodiments, the multi-layer film of the present disclosure includes a first outer layer, a second outer layer, a core layer between the first outer layer and the second outer layer, a first inner layer and a second inner layer, where the first inner layer and the second inner layer are positioned between the first outer layer and the second outer layer. At least one of the first outer layer and the second outer layer comprises a first polyethylene. The core layer has a thickness that is 8 to 30 percent (%) of a total thickness of the multi-layer film. In addition, the core layer is formed from a core polymer comprising 20 to 0 weight percent (wt. %) of a second polyethylene and 80 to 100 wt. % of a propylene-based elastomer having a density of 0.855 g/cm³ to 0.877 g/cm³, the wt. % based on a total weight of the core layer. The multi-layer film comprises 8 to 30 wt. % of the propylene-based elastomer, based on the total wt. % of the multi-layer film. At least one of the first inner layer and the second inner layer comprise 80 to 100 wt. % of a linear low-density polyethylene (LLDPE) having a density of 0.870 g/cm³ to 0.912 g/cm³ and 20 to 0 wt. % of a low-density polyethylene (LDPE).

For the various embodiments, the core layer can be positioned between the first inner layer and the second inner layer. For the various embodiments, the core layer can be formed as a single layer of the core polymer. For the various embodiments, the propylene-based elastomer can contain 9 to 20 wt. % of ethylene based on a total weight of the propylene-based elastomer. For the present embodiments, the core layer can also have a thickness from 8 to 10% of a total thickness of the multi-layer film.

In additional embodiment, the first polyethylene of at least one of the first outer layer and the second outer layer can comprises 80 to 95 wt. % of an LLDPE having a density of 0.898 to 0.918 g/cm³ and 20 to 5 wt. % of an LDPE with a density 0.917 to 0.925 g/cm³, where the wt. % is based on a total weight of the first polyethylene of the at least one of the first outer layer and the second outer layer. The multi-layer film can have a thickness ranging from 60 μm to 120 μm. As discussed herein, the multi-layer film of the present disclosure can be used to form a stretch hood.

### BRIEF DESCRIPTION OF THE DRAWINGS DESCRIPTION

FIG. 1 is a schematic illustrating a cross section of a multi-layer film useful in making stretch hood film according to the present disclosure.

### DETAILED DESCRIPTION

The present disclosure provides for a multi-layer film that helps to resist machine direction tears in stretch hood films. In addition, the multi-layer film of the present disclosure helps to achieve improved reduction in machine direction tear failure all while being downgauged, which helps to reduce raw material usage while improving pallet load containment. In addition to improvements in reducing machine direction tear failures and reducing raw material usage via downgauging the multi-layer film of the present disclosure improves load stability, which again help with pallet load containment.

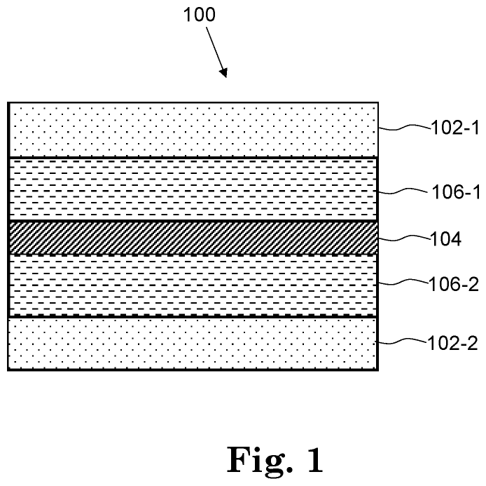

FIG. 1 provides for an embodiment of a multi-layer film 100 of the present disclosure. As illustrated, the multi-layer film 100 includes five (5) layers. Specifically, the multi-layer film 100 includes a first outer layer 102-1, a second outer layer 102-2, a core layer 104 between the first outer layer 102-1 and the second outer layer 102-2, a first inner layer 106-1 and a second inner layer 106-2.

In FIG. 1, the core layer 104 is shown positioned between the first inner layer 106-1 and the second inner layer 106-2. In an alternative embodiment, the core layer 104 can be positioned between the first inner layer 106-1 and the first outer layer 102-1. Alternatively, the core layer 104 can be positioned between the second inner layer 106-2 and the second outer layer 102-2. In an additional embodiment, the multi-layer film of the present disclosure can have more than five layers. For example, the multi-layer film of the present disclosure can have six (6) layer, seven (7) layers or more. Even with this multi-layer structure, the multi-layer film has a thickness ranging from 60 μm to 120 μm. As discussed herein, the multi-layer film of the present disclosure can be used to form a stretch hood.

Unless stated to the contrary, implicit from the context, or customary in the art, all parts and percentages herein are based on the total weight of the material (e.g., the core polymer, as discussed herein) being discussed, all temperatures are in degree Celsius (° C.), and all test methods are current as of the filing date of this disclosure.

The term “composition,” as used herein, refers to a mixture of materials that comprise the composition, as well as reaction products and decomposition products formed from the materials of the composition.

“Polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), the term copolymer and the term interpolymer as defined hereinafter. Trace amounts of impurities (for example, catalyst residues) may be incorporated into and/or within the polymer. A polymer may be a single polymer, a polymer blend or polymer mixture.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The term “polyolefin”, as used herein, refers to a polymer that comprises, in polymerized form, a majority amount of olefin monomer, for example ethylene or propylene (based on the weight of the polymer), and optionally may comprise one or more comonomers.

The terms “comprising,” “including,” “having,” and their derivatives, are not intended to exclude the presence of any additional component, step or procedure, whether or not the same is specifically disclosed. To avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

“Polyethylene” shall mean polymers comprising greater than 50% by weight of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference).

The term “LLDPE”, includes both resin made using the traditional Ziegler-Natta catalyst systems as well as single-site catalysts, including, but not limited to, bis-metallocene catalysts (sometimes referred to as “m-LLDPE”) and constrained geometry catalysts, and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. Nos. 3,914,342 or 5,854,045). The LLDPEs can be made via gas-phase, solution-phase or slurry polymerization or any combination thereof, using any type of reactor or reactor configuration known in the art.

The term “multilayer film” refers to a film having five (5) or more layers formed from the polymer compositions as provided herein. In addition to multilayer films, the present disclosure can allow for, without limitation, multilayer sheets, laminated films, multilayer rigid containers, multilayer pipes, and multilayer coated substrates.

Unless otherwise indicated herein, the following analytical methods are used in the describing aspects of the present disclosure:

“Density” is determined in accordance with ASTM D792.

“Melt index”: Melt indices 12 (or 12) is measured in accordance with ASTM D-1238 at 190° C. and at a 2.16 kg load. The values are reported in g/10 min. “Melt flow rate” is determined according to ASTM D1238 (230° C. at 2.16 kg).

Additional properties and test methods are described further herein.

### Core Layer

For the various embodiments, the core layer of the multi-layer film has a thickness that is 8 to 30 percent (%) of a total thickness of the multi-layer film. For the present embodiment, the core layer can also have a thickness from 8 to 10% of a total thickness of the multi-layer film. For example, the core layer can have a total thickness from a lower limit of 16%, 15%, 13%, 12%, 10%, 9.6%, or 8% of a total thickness of the multi-layer film to an upper limit of 20%, 23%, 25%, 26%, 27%, 29%, or 30% of a total thickness of the multi-layer film. Examples of total thickness for the core layer include 8 to 30% of a total thickness of the multi-layer film, including all individual values in between. For example, the core layer can have a total thickness from 16 to 20%, 15 to 23%, 13 to 25%, 12 to 26%, 10 to 27%, 9.6 to 29%, 8 to 20%, or 16 to 29% of a total thickness of the multi-layer film.

For the various embodiments, the core layer is formed from a core polymer. The core polymer comprises 20 to 0 wt. % of a second polyethylene and 80 to 100 wt. % of a propylene-based elastomer having a density of 0.850 to 0.902 g/cm³, where the wt. % is based on a total weight of the core layer. The second polyethylene has a density from 0.870 to 0.912 g/cm³ and a melt index from 0.5 to 1.1 g/10 min. Preferably, the propylene-based elastomer has a density of 0.855 to 0.892 g/cm³, and more preferably from 0.855 to 0.877 g/cm³.

In various embodiments, the multi-layer film comprises 8 to 30 wt. % the propylene-based elastomer including all individual values in between, based on the total wt. % of the multi-layer film. For the present embodiment, the multi-layer film can also comprise from 8 to 10 wt. % of the multi-layer film. For example, the multi-layer film can comprise from a lower limit of 16 wt. %, 15 wt. %, 13 wt. %, 12 wt. %, 10 wt. %, 9.6 wt. %, or 8 wt. % of the multi-layer film to an upper limit of 20 wt. %, 23 wt. %, 25 wt. %, 26 wt. %, 27 wt. %, 29 wt. %, or 30 wt. % of the multi-layer film. For example, the multi-layer film can comprise from 16 to 20 wt. %, 15 to 23 wt. %, 13 to 25 wt. %, 12 to 26 wt. %, 10 to 27 wt. %, 9.6 to 29 wt. %, 8 to 20 wt. %, or 16 to 29 wt. % of the multi-layer film.

The propylene-based elastomer is comprised from units derived from propylene and from polymeric units derived from alpha-olefins. The preferred alpha-olefins utilized in forming the propylene-based elastomer include C2 and C4 to C10 alpha-olefins, preferably C2, C4, C6 and C8 alpha-olefins, and most preferably C2 (ethylene).

The propylene-based elastomer preferably comprises from 10 to 33 mole percent units derived from alpha-olefins, more preferably from 13 to 27 mole percent units derived from alpha-olefins. When ethylene is the alpha-olefin, the propylene-based elastomer contains 80 to 91 wt. % of units derived from propylene and 9 to 20 wt. % of units derived from ethylene based on a total weight of the propylene-based elastomer. Preferably, the propylene-based elastomer contains 85 to 90 wt. % of units derived from propylene and 10 to 15 wt. % of units derived from ethylene based on a total weight of the propylene-based elastomer. More preferably, the propylene-based elastomer contains 86 to 89 wt. % of units derived from propylene and 11 to 14 wt. % of units derived from ethylene based on a total weight of the propylene-based elastomer. Most preferably, the propylene-based elastomer contains 87 to 89 wt. % of units derived from propylene and 11 to 13 wt. % of units derived from ethylene based on a total weight of the propylene-based elastomer.

For the various embodiments, the propylene-based elastomer can have a crystallinity from 1 wt. % (a heat of fusion of at least 2 Joules/gram) to 30 wt. % (a heat of fusion of less than 50 Joules/gram), more preferably 1 to 24 wt. % (a heat of fusion of less than 40 Joules/gram), further more preferably 1 to 15 wt. % (a heat of fusion of less than 24.8 Joules/gram), and where handling is not a problem (i.e., sticky polymers can be utilized) preferably 1 to 7 wt. % (a heat of fusion of less than 11 Joules/gram), even more preferably 1 to 5 wt. % (a heat of fusion of less than 8.3 Joules/gram), all determined in accordance with the DSC method provided in WO 2007/044544 A2, incorporated herein by reference in its entirety. The crystallinity of the propylene-based elastomer is preferably from 2.5 wt. % (a heat of fusion of at least 4 Joules/gram) to 30 wt. %, more preferably from 3 wt. % (a heat of fusion of at least 5 Joules/gram) to 30 wt. %.

The melt flow rate of the propylene-based elastomer is preferably from a lower value of 0.1 g/10 min and more preferably of 0.2 g/10 min to an upper value of 10 g/10 min, preferably of 8 g/10 min, more preferably to 4 g/10 min and most preferably to 2 g/10 min to achieve good processability. The propylene-based elastomer also has a molecular weight distribution (MWD), defined as weight average molecular weight divided by number average molecular weight (Mw/Mn) of 1.0 to 3.5, more preferably from 1.0 to 3.0, most preferably 1.8 to 3.0. Techniques for measuring the weight average molecular weight and the number average molecular weight include, but are not limited to, static light scattering or gel permeation chromatography (GPC) using polystyrene standards, as are known in the art and as described in WO 2007/044544 A2, incorporated herein by reference in its entirety.

For the various embodiments, the propylene-based elastomer of the core polymer can be formed according to the method described in WO 2007/044544 A2, incorporated herein by reference in its entirety. Briefly, the propylene-based elastomer of the core polymer is formed using a non-metallocene, metal-centered, heteroaryl ligand catalyst as described in U.S. patent application Ser. No. 10/139,786 filed May 5, 2002 (WO 03/040201), which are incorporated by reference herein in their entirety for their teachings regarding such catalysts.

For the various embodiments, the core layer can be formed as a single contiguous layer of the core polymer as provided herein. So, for example the core layer may comprise a single contiguous layer of the five-layer film as seen in FIG. 1 or as a core layer in a seven-layer film, where the core layer is between the outer layers and the inner layers as provided herein. As discussed herein, the core layer may be positioned between the first inner layer and the second inner layer of a multi-layer film regardless of the number of layers present in the multi-layer film. In some embodiment, the core layer is positioned directly between and in contact with the first inner layer and the second inner layer. In additional embodiments, the core layer is positioned directly between and in contact with the first outer layer and the first inner layer or the core layer is positioned directly between and in contact with the second outer layer and the second inner layer.

For the various embodiments, the core layer is formed from a single contiguous (e.g., discrete) layer of the core polymer and is not formed using two or more contiguous layers (e.g., two or more separate layers) of the core polymer.

Commercial examples of the core polymer can include those provided under the tradename VERSIFY™ available from The Dow Chemical Company (TDCC), where a preferred example is VERSIFY™ 2300 propylene elastomer from TDCC. Other commercial examples of the core polymer can include those provided under the tradename “VISTAMAXX” available from ExxonMobil Chemical.

### First Outer Layer and Second Outer Layer

The multi-layer film also includes the first outer layer and the second outer layer that each comprise a first polyethylene. The first polyethylene can be an LLDPE, an LDPE, or a blend of the LLDPE and the LDPE, as provided herein. Each of the first outer layer and the second outer layer have a thickness that is 10 to 30% of the total thickness of the multi-layer film. Preferably, each of the first outer layer and the second outer layer has a thickness from 20 to 30% of the total thickness of the multi-layer film. More preferably, each of the first outer layer and the second outer layer has a thickness from 20 to 25% of the total thickness of the multi-layer film. Most preferably, each of the first outer layer and the second outer layer has a thickness from 22 to 25% of the total thickness of the multi-layer film. In addition, each of the first outer layer and the second outer layer can constitute from 15 to 30 wt. % of the first polyethylene based on the total weight of the multi-layer film, and preferably from 15 to 20 wt. % of the total weight of the multi-layer film.

In additional embodiments, the first polyethylene of at least one of the first outer layer and the second outer layer can comprise 80 to 95 wt. % of the LLDPE having a density of 0.898 to 0.918 g/cm³, where the wt. % is based on a total weight of the first polyethylene of the at least one of the first outer layer and the second outer layer. Preferably, the first polyethylene comprises 80 to 90 wt. % and more preferably 80 to 85 wt. % of LLDPE. In addition, the first polyethylene of at least one of the first outer layer and the second outer layer can comprise comprises 20 to 5 wt. % of the LDPE with a density 0.917 to 0.925 g/cm³, where the wt. % is based on a total weight of the first polyethylene of the at least one of the first outer layer and the second outer layer. Preferably, the first polyethylene comprises 20 to 10 wt. % and more preferably 20 to 15 wt. % of LDPE. Preferably, both the first outer layer and the second outer layer are formed from the first polyethylene, as provided herein.

The LLDPE of the first polyethylene of at least one of the first outer layer and the second outer layer has an MWD from 2 to 8, more preferably 2 to 6 and most preferably 2 to 4. MWD is calculated as described herein. Those skilled in the art are aware that polymers having a MWD less than 3 is conveniently made using a metallocene or constrained geometry catalyst (especially in the case of ethylene polymers) or using electron donor compounds with Ziegler Natta catalysts.

The LLDPE as used herein is a copolymer of units derived from at least 60 wt. % of ethylene and up to 40 wt. % of an alpha-olefin comonomer. The preferred alpha-olefin comonomers are C4 to C10 alpha-olefins, more preferably C4 to C8 alpha-olefins, even more preferably C4, C5, C6 and C8 alpha-olefins and most preferably 1-butene, 1-hexene and 1-octene. Due to their superior film strength properties (such as tear resistance, Dart impact strength and holding force), polyethylene copolymers made at least partially with Ziegler-Natta catalyst systems are preferred.

The LLDPE may be made using gas phase, solution, or slurry polymer manufacturing processes. Due to their excellent machine direction tear strength, dart impact resistance and other balance of properties, ethylene/1-octene and ethylene/1-hexene copolymers made in the solution polymerization process are most preferred. The LLDPE utilized in this disclosure have a density of from 0.900 to 0.923 g/cm³, preferably from 0.902 to 0.922 g/cm³ and more preferably from 0.904 to 0.920 g/cm³.

Examples of suitable LLDPE include ethylene/1-octene and ethylene/1-hexene linear copolymers available from The Dow Chemical Company under the tradename “DOWLEX™”, ethylene/1-octene linear copolymers available from The Dow Chemical Company under the tradename “ATTANE™”, ethylene/1-octene enhanced polyethylene available from The Dow Chemical Company under the tradename “ELITE™”, ethylene/alpha-olefin copolymers available from The Dow Chemical Company under the tradenames “Dowlex GM”, ethylene based copolymers available from Polimeri Europa under the tradenames “CLEARFLEX” and “FLEXIRENE”, ethylene/alpha-olefin copolymers available from ExxonMobil Chemical under the tradenames “Exact” and “Exceed”, ethylene/alpha olefin copolymers available from Innovex under the tradename “INNOVEX”, ethylene/alpha-olefin copolymers available from Basell under the tradenames “LUFLEXEN” and “LUPOLEX”, ethylene/alpha-olefin copolymers available from Dex Plastomers under the tradename “STAMYLEX”, and ethylene/alpha-olefin copolymers available from Sabic under the tradename “LADENE”.

The LDPE of the first polyethylene of at least one of the first outer layer and the second outer layer has a melt index (MI) from 0.1 to 9 g/10 min, more preferably from 0.2 to 6 g/10 min, even more preferably from 0.2 to 4 g/10 min and most preferably from 0.25 to 2 g/10 min. Melt index is inversely proportional to the molecular weight of the polymer. Thus, the higher the molecular weight, the lower the melt index, although the relationship is not linear.

The LDPE can have a density 0.917 to 0.925 g/cm³. Preferably, the LDPE has a density of 0.917 to 0.922 g/cm³.

The LDPE used in this disclosure is made using the high pressure free radical manufacturing process known to one of ordinary skill in the art. The LDPE's are typically homopolymers but may contain a small amount of comonomer (less than one percent (1%) by weight units derived from comonomers.

Commercial examples of the LDPE can be purchased from various manufacturers. For example, LDPE can be purchased from The Dow Chemical Company as DOW® LDPE 150E, 303E, 320E, 310E, 450 and many other grades, and from LyondellBasell Industries under the tradenames of “LUPOLEN” and “PETROTHENE”.

### First Inner Layer and Second Inner Layer

The multi-layer film also includes the first inner layer and the second inner layer. Each of the first inner layer and the second inner layer has a thickness that is 10 to 31% of the total thickness of the multi-layer film. Preferably, each of the first inner layer and the second inner layer has a thickness from 15 to 30% of the total thickness of the multi-layer film. More preferably, each of the first inner layer and the second inner layer has a thickness from 20 to 27% of the total thickness of the multi-layer film. Most preferably, each of the first inner layer and the second inner layer has a thickness from 22 to 25% of the total thickness of the multi-layer film.

For the various embodiments, at least one of the first inner layer and the second inner layer comprise 80 to 100 wt. % of the LLDPE, as described herein, having a density of 0.870 to 0.912 g/cm³ and 20 to 0 wt. % of the LDPE, as described herein. Preferably, the first inner layer and the second inner layer comprise 85 to 100 wt. % of the LLDPE and 15 to 0 wt. % of the LDPE, and more preferably from 90 to 100 wt. % of the LLDPE and 10 to 0 wt. % of the LDPE. In some embodiments, each of the first inner layer and the second inner layer has a total density from 0.902 to 0.907 g/cm³ and a melt index from 0.7 to 1.1 g/10 min.

In various embodiments, the first inner layer and the second inner layer are positioned between the first outer layer and the second outer layer. In some embodiment, the first inner layer is positioned directly between and in contact with the first outer layer and the core layer and the second inner layer is positioned directly between and in contact with the second outer layer and the core layer. In an alternative embodiment, the core layer is positioned directly between and in contact with the first outer layer and the first inner layer and the second inner layer is positioned directly between and in contact with the second outer layer and the first inner layer. In another embodiment, the core layer is positioned directly between and in contact with the second outer layer and the second inner layer and the first inner layer is positioned directly between and in contact with the first outer layer and the second inner layer.

### Forming Multi-Layer Film

Multi-layer films may generally be produced using techniques known to those of skill in the art based on the teachings herein. For example, the multi-layer film may be produced by coextrusion. The technique of multi-layer film extrusion is well known for the production of thin plastic films. Suitable multi-layer film processes are described, for example, in The Encyclopedia of Chemical Technology, Kirk-Othmer, Third Edition, John Wiley & Sons, New York, 1981, Vol. 16, pp. 416-417 and Vol. 18, pp. 191-192.

The formation of coextruded multi-layer films is known in the art and applicable to the present disclosure. The term “coextrusion” refers to the process of extruding two or more materials through a single die with two or more orifices arranged such that the extrudates merge together into a laminar structure, preferably before chilling or quenching. Coextrusion systems for making multi-layer films employ at least two extruders feeding a common die assembly. The number of extruders is dependent upon the number of different materials comprising the coextruded film. For each different material, a different extruder is used. Thus, a five-layer coextrusion may require up to five extruders although less may be used if two or more of the layers are made of the same material.

In multi-layer films each layer advantageously imparts a desired characteristic such as weatherability, heat seal, adhesion, chemical resistance, barrier layers (e.g. to water or oxygen), elasticity, shrink, durability, hand and feel, noise or noise reduction, texture, embossing, decorative elements, impermeability, stiffness, and the like. Adjacent layers of the multi-layer film are optionally directly adhered to each other, or alternatively may have an adhesive, tie or other layer between them, particularly for the purpose of achieving adhesion there between. Constituents of the layers are selected to achieve the desired purpose.

The multi-layer films may be used for a variety of causes, such as, shrink wrap film, stretch hood film and the like as are known in the art. For example, the multi-layer film of the present disclosure is preferably used in forming a stretch hood film.

### Stretch Hood Film

For use as a stretch hood, the multi-layer film of the present disclosure is preferably from 60 to 120 μm thick and made with a blow-up-ratio of 3.0 to 4.0. Such multi-layer films help to avoid punctures and tearing during production and use in stretch hood applications and exhibit load containment. In addition to the other physical properties discussed earlier with respect to the multi-layer film structures, in stretch hood end-use applications, the multi-layer film structure typically exhibits machine direction tear of at least 1900 grams and often much higher. For instance, the machine direction tear of the multi-layer film of the present disclosure ranges from 1900 to 3450 g, as measured according to the procedures of ASTM D1922-09.

### Additives

The first outer layer and the second outer layer may further comprise one or more additives. Additives are optionally included in the first inner layer, second inner layer, and/or core layer. Additives are well within the skill in the art. Such additives include, for instance, stabilizers including free radical inhibitors and ultraviolet wave (UV) stabilizers, neutralizes, nucleating agents, slip agents, antiblock agents, pigments, antistatic agents, clarifiers, waxes, resins, fillers such as silica and carbon black and other additives within the skill in the art used in combination or alone. Effective amounts are known in the art and depend on parameters of the polymers in the composition and conditions to which they are exposed.

As is known to one of skill in the art, antiblock additives are additives that when added to polymer films minimize the tendency of the film to stick to another film or itself during manufacturing, transport and storage. Typical materials used as antiblocks include silica, talc, clay particles, and other substances known to one of ordinary skill in the art.

As is known to one of skill in the art, slip additives are additives that when added to polymer films lower the coefficient of friction of the film. Typical materials used as slip agents include erucamide, oleamide, and other substances known to one of ordinary skill in the art.

### Examples

In the Examples, various terms and designations for materials were used including, for example, the following:

TABLE 1
List of Materials and Properties

| | | | Melt Index |
|---|---|---|---|
| | | Density | 190° C., |
| Material/Source | Type | (g/cm³) | 2.16 kg |
| DOWLEX ™ GM | Linear Low-Density | 0.916 | 1.0 |
| 8090 The Dow | Polyethylene (LLDPE) | | |
| Chemical Company | | | |
| (TDCC) | | | |
| ELITE AT ™ 6410 | LLDPE | 0.912 | 0.85 |
| TDCC | | | |
| Low-Density | LDPE | 0.921 | 0.25 |
| Polyethylene (LDPE) | | | |
| 150E ™ TDCC | | | |
| LLDPE Copolymer | LLDPE | 0.902 | 0.85 |
| TDCC | | | |
| Versify ™ 2300 | Propylene (PP) Elastomer | 0.867 | 2.0* |
| TDCC | | | |
| Schulman T9530 | 5% Stearyl Erucamide/10% | 1.01 | 15 |
| A. Schulman, Inc, | Natural Silica masterbatch | | |
| Schulman UVK90 | 10% HALS UV | 1.26 | 2 |
| A. Schulman, Inc, | Masterbatch | | |

*Melt index is measured at 230°, 2.16 kg

Produce the multi-layer film with the materials described in Table 1. Examples (EX) of the multi-layer films seen in Table 5 are produced with a propylene-based elastomer core layer between two layers of LLDPE Copolymer. Comparative Examples (CE) of the multi-layer films seen in Table 5 include a propylene-based elastomer blended with LLDPE Copolymer, a propylene-based elastomer between two layers of propylene-based elastomer, or a propylene-based elastomer between a propylene-based elastomer layer and a LLDPE Copolymer layer. The LLDPE Copolymer copolymer is made with the procedure described below.

The LLDPE Copolymer is made by purifying all raw materials (monomer and comonomer) and the process solvent (a narrow boiling range high-purity isoparaffinic solvent, Isopar-E) with molecular sieves before introducing them into the reaction environment. The hydrogen is supplied pressurized and is made from a high purity grade that is not further purified. Pressurize, the reactor monomer feed stream with a mechanical compressor to the reactor pressure found in Table 2. Also, pressurize the solvent and comonomer feed with a pump to the reactor pressure found in Table 2. Each individual catalyst component is manually batch diluted with purified solvent to the reactor pressure found in Table 2. All reaction feed flows are measured with mass flow meters and independently controlled with computer automated valve control systems.

A two-reactor system is used in a series configuration. Each continuous solution polymerization reactor comprises a liquid full, non-adiabatic, isothermal, circulating, loop reactor which mimics a continuously stirred tank reactor (CSTR) with heat removal. Independent control of all fresh solvent, monomer, comonomer, hydrogen, and catalyst component feeds is possible. The total fresh feed stream (solvent, monomer, comonomer, and hydrogen) to each reactor is temperature controlled to maintain a single solution phase by passing the feed stream through a heat exchanger. The total fresh feed to each polymerization reactor is injected into the reactor at two locations (e.g., the first reactor and the second reactor) with approximately equal reactor volumes between each injection location. The fresh feed is controlled by each injector receiving half of the total fresh feed mass flow. Inject the catalyst components into the polymerization reactor. The primary catalyst component feed is computer controlled to maintain each reactor monomer conversion at the specified targets. The co-catalyst components are fed based on calculated specified molar ratios to the primary catalyst component. Immediately following each reactor feed injection location, the feed streams are mixed with the circulating polymerization reactor contents with static mixing elements. The contents of each reactor are continuously circulated through heat exchangers responsible for removing much of the heat of reaction and with the temperature of the coolant side responsible for maintaining an isothermal reaction environment at the specified temperature. Circulation around each reactor loop is provided by a pump.

In dual series reactor configuration the effluent from the first polymerization reactor (containing solvent, monomer, comonomer, hydrogen, catalyst components, and polymer) exits the first reactor loop and is added to the second reactor loop.

The second reactor effluent enters a zone where it is deactivated with the addition of a suitable reagent (e.g., water). At this same reactor exit location other additives are added for polymer stabilization (typical antioxidants suitable for stabilization during extrusion and film fabrication like Octadecyl 3,5-Di-Tert-Butyl-4-Hydroxyhydrocinnamate, Tetrakis (Methylene(3,5-Di-Tert-Butyl-4-Hydroxyhydrocinnamate)) Methane, and Tris (2,4-Di-Tert-Butyl-Phenyl) Phosphite).

Following catalyst deactivation and additive addition, the reactor effluent enters a devolatization system where the polymer is removed from the non-polymer stream. The isolated polymer melt is pelletized and collected.

TABLE 2

| Process | Unit | Value |
|---|---|---|
| Reactor Configuration | | Dual Series |
| Comonomer type | | 1-octene |
| First Reactor Feed Solvent/Ethylene Mass | g/g | 5.7 |
| Flow Ratio | | |
| First Reactor Feed Comonomer/Ethylene | g/g | 0.56 |
| Mass Flow Ratio | | |
| First Reactor Feed Hydrogen/Ethylene | g/g | 2.0E−05 |
| Mass Flow Ratio | | |
| First Reactor Temperature | ° C. | 180 |
| First Reactor Pressure | barg | 50 |
| First Reactor Ethylene Conversion | % | 91.0 |
| First Reactor Catalyst Type | | Catalyst |
| | | component 1 |
| First Reactor Co-Catalyst 1 Type | | Co-catalyst 1 |
| First Reactor Co-Catalyst 2 Type | | Co-catalyst 2 |
| First Reactor Co-Catalyst 1 to Catalyst | Ratio | 1.2 |
| Molar Ratio (B to Zr ratio) | | |
| First Reactor Co-Catalyst 2 to Catalyst | Ratio | 20.0 |
| Molar Ratio (Al to Zr ratio) | | |
| First Reactor Residence Time | min | 10.6 |
| Second Reactor Feed Solvent/Ethylene | g/g | 2.4 |
| Mass Flow Ratio | | |
| Second Reactor Feed Comonomer/Ethylene | g/g | 0.233 |
| Mass Flow Ratio | | |
| Second Reactor Feed Hydrogen/Ethylene | g/g | 6.3^{E-04} |
| Mass Flow Ratio | | |
| Second Reactor Temperature | ° C. | 190 |
| Second Reactor Pressure | barg | 50 |
| Second Reactor Ethylene Conversion | % | 86.4 |
| Second Reactor Catalyst Type | | Catalyst |
| | | component 1 |
| Second Reactor Co-Catalyst 1 Type | | Co-catalyst 1 |
| Second Reactor Co-Catalyst 2 Type | | Co-catalyst 2 |
| Second Reactor Co-Catalyst 1 to Catalyst | mol/mol | 1.2 |
| Molar Ratio (B to Zr ratio) | | |
| Second Reactor Co-Catalyst 2 to Catalyst | mol/mol | 5.0 |
| Molar Ratio (Al to Zr ratio) | | |
| Second Reactor Residence Time | min | 7.1 |

TABLE 3

| | |
|---|---|
| Catalyst | dimethyl[[2,2′″-[1,3-propanediylbis(oxy- |
| component 1 | .kappa.O)]bis[3″,5,5″-tris(1,1-dimethylethyl)-5′- |
| | methyl[1,1′:3′,1″-terphenyl]-2′-olato-.kappa.O]](2-)]-, |
| | (OC-6-33)-zirconium |
| Co-catalyst 1 | bis(hydrogenated tallow alkyl)methylammonium |
| | tetrakis(pentafluorophenyl)borate(1-) |
| Co-catalyst 2 | modified methyl aluminoxane |

The multi-layer films of Table 5 are produced by extruding the multi-layer films on a Collin coextrusion blown film line, with a Blow-up Ratio (BUR) of 3.5 and a total thickness of 100 μm. The Collin coextrusion blown film line is produced by Collin Lab & Pilot Solutions GmbH. The Collin coextrusion blown film line is configured as shown in Table 4 below to prepare the multi-layer films in Table 5:

TABLE 4

| | |
|---|---|
| Maximum hauloff speed | 30 m/min |
| Extruders size 9 Layers 9 extruders: | 5(extr) × 20-25D (A/B/C/D/E)/ |
| | 4(extr) × 25-25D (F/G/H/I) |
| Die size | 100 mm |
| Die Gap | 1.8 mm |
| Max. Output | 8-50 kg/hour |
| Extruder size distribution: | 20 mm/25 mm/25 mm/20 mm/ |
| | 20 mm/20 mm/25 mm/25 mm/ |
| | 20 mm |
| Thickness working range | 10-250 micron |
| Max. Layflat width | 550 mm |

The Comparative Examples of the multi-layer films in Table 5 include a combined core layer. For example, the first inner layer, the core layer, and the second inner layer of the multi-layer films in Table 5 may be combined (Comparative Examples B, C, D, E, and F) or the first inner layer and the core layer of the multi-layer films in Table 5 may be combined (Comparative Example A).

TABLE 5

| | | | | | Second | Total |
|---|---|---|---|---|---|---|
| | | | | | Outer | Versify |
| | First Outer | First Inner | Core Layer | Second Inner | Layer | Content |
| | Layer (20 μ) | Layer (25 μ) | (10 μ) | Layer (25 μ) | (20 μ) | (%) |
| Example | DOWLEX | LLDPE | Versify 2300 | LLDPE | DOWLEX | 10 |
| (EX) 1 | GM 8090 + | Copolymer | | Copolymer | GM 8090 + | |
| | LDPE 150E | | | | LDPE | |
| | 15% | | | | 150E 15% | |
| | | | | | Second | |
| | | | | | Outer | Total |
| | First Outer | First Inner | Core Layer | Second Inner | Layer | Versify |
| | Layer (20 μ) | Layer (20 μ) | (20 μ) | Layer (20 μ) | (20 μ) | Content |
| EX 2 | DOWLEX | LLDPE | Versify 2300 | LLDPE | DOWLEX | 20 |
| | GM 8090 + | COPOLYMER | | Copolymer | GM 8090 + | |
| | LDPE 150E | | | | LDPE | |
| | 15% | | | | 150E 15% | |
| Comparative | DOWLEX | Versify 2300 | Versify 2300 | LLDPE | DOWLEX | 40 |
| Example | GM 8090 + | | | Copolymer | GM 8090 + | |
| (CE) A | LDPE 150E | | | | LDPE | |
| | 15% | | | | 150E 15% | |
| CE B | DOWLEX | Versify 2300 | Versify 2300 | Versify 2300 | DOWLEX | 60 |
| | GM 8090 + | | | | GM 8090 + | |
| | LDPE 150E | | | | LDPE | |
| | 15% | | | | 150E 15% | |
| CE C | DOWLEX | LLDPE | LLDPE | LLDPE | DOWLEX | 10 |
| | GM 8090 + | Copolymer + | Copolymer + | Copolymer + | GM 8090 + | |
| | LDPE 150E | 16% Versify | 16% Versify | 16% Versify | LDPE | |
| | 15% | 2300 | 2300 | 2300 | 150E 15% | |
| CE D | DOWLEX | LLDPE | LLDPE | LLDPE | DOWLEX | 20 |
| | GM 8090 + | Copolymer + | Copolymer + | Copolymer + | GM 8090 + | |
| | LDPE 150E | 33% Versify | 30% Versify | 30% Versify | LDPE | |
| | 15% | 2300 | 2300 | 2300 | 150E 15% | |
| CE E | DOWLEX | LLDPE | LLDPE | LLDPE | DOWLEX | 40 |
| | GM 8090 + | Copolymer + | Copolymer + | Copolymer + | GM 8090 + | |
| | LDPE 150E | 66% Versify | 66% Versify | 66% Versify | LDPE | |
| | 15% | 2300 | 2300 | 2300 | 150E 15% | |
| CE F | DOWLEX | LLDPE | LLDPE | LLDPE | DOWLEX | 0 |
| | GM 8090 + | Copolymer | Copolymer | Copolymer | GM 8090 + | |
| | LDPE 150E | | | | LDPE | |
| | 15% | | | | 150E 15% | |

The multi-layer films of Table 7 are produced a five-layer Windmöller & Holscher OPTIMEX blown film line at an output rate of 300 kg/hr at an output rate of 300 kg/hr with a BUR of 3.8. The multi-layer films of Table 7 were produced at 100 μm and a downgauged thickness 80 μm to minimise raw material usage. All percent (%) values provided in Tables 7 are weight percent based on the total weight of each layer. The Windmöller & Holscher OPTIMEX blown film line is produced by Windmöller & Holscher Corporation. The Windmöller & Holscher OPTIMEX blown film line is configured as shown in Table 6 below to prepare the multi-layer films in Table 7:

TABLE 6

| | |
|---|---|
| Maximum hauloff speed | 30 m/min |
| Extruders size 5 Layers 5 extruders: | 5(extr) × 30D (A/B/C/D/E) |
| Die size | 300 mm |
| Die Gap | 2.25 mm |
| Max. Output | 400 kg/hour |
| Extruder size distribution: | 60 mm/70 mm/90 mm/ |
| | 70 mm/60 mm |
| Thickness working range | 20-250 micron |
| Max. Layflat width | 2000 mm |

The Examples of the multi-layer films in Table 7 include a blended core layer. For example, the core layer of Examples 3 and 4 include a blend of a Versify 2300 and Schulman UVK90.

TABLE 7
Multi-layer Structures Extruded in OPTIMEX blown film line

| | | | | | Second | Total |
|---|---|---|---|---|---|---|
| | First Outer | First Inner | Core Layer | Second Inner | Outer Layer | Versify |
| | Layer (15 μ) | Layer (20 μ) | (30 μ) | Layer (20 μ) | (15 μ) | Content |
| EX 3 | Elite AT | LLDPE | Versify 2300 + | LLDPE | Elite AT | 29 |
| | 6410 + | Copolymer + | 3% UVK90 | Copolymer + | 6410 + | |
| | LDPE 150E | 3% UVK90 | | 3% UVK 90 | LDPE 150E | |
| | 15% + 4% | | | | 15% + 4% | |
| | T9530 + 3% | | | | T9530 + 3% | |
| | UVK90 | | | | UVK90 | |
| | | | | | Second | Total |
| | First Outer | First Inner | Core Layer | Second Inner | Outer Layer | Versify |
| | Layer (12 μ) | Layer (16 μ) | (24 μ) | Layer (16 μ) | (12 μ) | Content |
| EX 4 | Elite AT | LLDPE | Versify 2300 + | LLDPE | Elite AT | 29 |
| | 6410 + | Copolymer + | 3% UVK90 | Copolymer + | 6410 + | |
| | LDPE 150E | 3% UVK90 | | 3% UVK 90 | LDPE 150E | |
| | 15% + 4% | | | | 15% + 4% | |
| | T9530 + 3% | | | | T9530 + 3% | |
| | UVK90 | | | | UVK90 | |

### Testing Methods

### Tear Resistance

Tear resistance of the multi-layer film in both the machine direction (MD) and cross direction (CD) are valuable data for assessing any film for pallet unitization. Conduct the tear resistance test for the multi-layer film in accordance with ASTM D1922-09. The ASTM D1922-09 standard determines the average force to propagate tearing in the machine and cross direction through a specified length of plastic film after the tear has been started.

### Load Stability Test

Load stability test determine the integrity and the security of a palletized load secured with a film during transport. The load stability test is conducted for the multi-layer film in accordance with EUMOS 40509. The EUMOS 40509 is an international standard applicable for load units subject to horizontal accelerations of 0 to 2 g (e.g., loads transported within trucks). The EUMOS 40509 describes a test method to quantify the rigidity of a load unit in a specified direction when subject to an inertia force in that direction. The permanent displacement of the palletized test load in a horizontal direction should not be more than 5% of the height. The height of the pallet used is 180 cm. As such, the permanent displacement should be less than 9 cm. The load stability was checked using the tilting test, based on EN 12195 Norm. However, the criteria to evaluate the permanent displacement is based in EUMOS 40509.

### Results

The data presented in Table 8 demonstrates that Examples (EX) 1-3 have an increased tear resistance in the machine direction and cross direction compared to Comparative Examples A-F. Examples 4 has a machine direction tear resistance similar to the Comparative Examples with 100 μm thickness, however Example 4 is produced with a thickness of 80 μm (e.g., 20% less materials than the Comparative Examples). The multi-layer films with a discrete versify 2300 core layer (EX 1-4) produced a higher tear resistance in the machine direction and cross direction. Using a discrete versify 2300 core layer increases the tear resistance without diminishing the other properties of the film. For example, the Examples of the disclosure are able to maintain or improve load stability while increasing the tear resistance. That is, the Examples shown in Table 8 demonstrate an excellent resistance to tearing in the machine direction and cross direction and more than acceptable levels for stretch hood applications (e.g., acceptable levels are considered to be approximately 750-1000 g).

TABLE 8

| | MD Tear (g) | CD Tear (g) |
|---|---|---|
| EX 1 | 2808 | 2709 |
| EX 2 | 2638 | 2810 |
| EX 3 | 3442 | 4120 |
| EX 4 | 1107 | 3165 |
| CE A | 1932 | 2140 |
| CE B | 1710 | 1812 |
| CE C | 1650 | 1662 |
| CE D | 1586 | 1610 |
| CE E | 1321 | 1309 |
| CE F | 752 | 1375 |

The data presented in Table 9 demonstrates that the permanent displacement for Examples 3 and 4 are well within the set standards. The permanent displacement for Examples 3 and 4 are below the maximum allowed 9 cm based on the height of the pallet. That is, Examples 3 and 4 of this disclosure exhibit high integrity in securing and maintaining load stability during transport and are able to maintain or improve load stability while increasing the tear resistance.

TABLE 9

| | Displacement | Displacement |
|---|---|---|
| | Long Side of | Short Side of |
| | pallet (cm) | pallet (cm) |
| EX 3 | 0.7 | 0.7 |
| EX 4 | 1.0 | 3.4 |

### CONCLUSION

The multi-layer film with a discrete layer of the propylene-based elastomer that comprises 8 to 30% of a total thickness of the multi-layer film produces a high quality multi-layer stretch hood film that facilitate significant downgauging.

The Examples (Ex. 1 and 2) produced on the Collin coextrusion blown film line exhibits enhanced properties compared to the Comparative Example films.

The Examples (Ex. 3 and 4) produced on the five-layer Windmöller & Holscher OPTIMEX blown film line performed extremely well during testing. The multi-layer stretch hood films produced on the five-layer Windmöller & Holscher OPTIMEX blown film line show high processability with good snapback quality and no tiger stripping. The Example multi-layer stretch hood films exhibit increased tear resistance in the machine and cross direction with increased load stability. The tear resistance for the multi-layer stretch hood films of this disclosure are high enough to facilitate significant downgauging (e.g., at least 20% as compared to films with no propylene-based elastomer layer or a thicker propylene-based elastomer layer) and still produce a high performance stretch hood films with increased load stability.

1. A multi-layer film, comprising:
a first outer layer and a second outer layer, wherein at least one of the first outer layer and the second outer layer comprises a first polyethylene;
a core layer between the first outer layer and the second outer layer, wherein a thickness of the core layer is 8 to 30% of a total thickness of the multi-layer film, wherein the core layer is formed from a core polymer comprised of 20 to 0 weight percent (wt. %) of a second polyethylene and 80 to 100 wt. % of a propylene-based elastomer having a density of 0.855 g/cm³ to 0.877 g/cm³, the wt. % based on a total weight of the core layer, wherein the multi-layer film comprises 8 to 30 wt. % of the propylene-based elastomer, based on a total wt. % of the multi-layer film; and
a first inner layer and a second inner layer between the first outer layer and the second outer layer, wherein at least one of the first inner layer and the second inner layer comprises 80 to 100 wt. % of a linear low-density polyethylene (LLDPE) having a density of 0.870 g/cm³ to 0.912 g/cm³ and 20 to 0 wt. % of a low-density polyethylene (LDPE).

2. The multi-layer film of claim 1, wherein the core layer is positioned between the first inner layer and the second inner layer.

3. The multi-layer film of claim 1, wherein the core layer is formed as a single layer of the core polymer.

4. The multi-layer film of claim 1, wherein the first polyethylene of at least one of the first outer layer and the second outer layer comprises 80 to 95 wt. % of an LLDPE having a density of 0.898 to 0.918 g/cm³ and 20 to 5 wt. % of an LDPE with a density of 0.917 to 0.925 g/cm³, wherein wt. % are based on a total weight of the first polyethylene of the at least one of the first outer layer and the second outer layer.

5. The multi-layer film of claim 1, wherein the thickness of the core layer is 8 to 10% of a total thickness of the multi-layer film.

6. The multi-layer film of claim 1, wherein the multi-layer film comprises 9.6 to 20 wt. % of the propylene-based elastomer, based on a total wt. % of the multi-layer film.

7. The multi-layer film of claim 1, wherein the propylene-based elastomer contains 9 to 20 wt. % of ethylene based on a total weight of the propylene-based elastomer.

8. The multi-layer film of claim 1, wherein the core polymer comprises 10 to 0 wt. % of the second polyethylene and 90 to 100 wt. % of the propylene-based elastomer having a density of 0.855 g/cm³ to 0.877 g/cm³, the wt. % based on the total weight of the core layer.

9. The multi-layer film of claim 1, wherein the multi-layer film has a thickness of 60 to 120 μm.

10. A stretch hood formed from the multi-layer film of claim 1.
